(19) United States
(12) Patent Application Publication
(10) Pub. No.: US 2024/0130380 A1
(43) Pub. Date: Apr. 25, 2024

(54) METHOD FOR OBTAINING A FOOD PRODUCT AND DELICACY FOR HUMAN CONSUMPTION FROM A CHICKEN BACK PIECE

(71) Applicant: Recep KOYUNCU, LEERDAM (NL)

(72) Inventor: Recep KOYUNCU, LEERDAM (NL)

(21) Appl. No.: 18/546,944

(22) PCT Filed: Feb. 17, 2022
(86) PCT No.: PCT/NL2022/050081

§ 371 Date: Aug. 16, 2023

(30) Foreign Application Priority Data
Feb. 18, 2021 (NL) 1043944

(51) Int. Cl. A22C 21/00

(52) U.S. Cl. CPC A22C 21/0069; A22C 21/0023

(57) ABSTRACT

Method for obtaining a food product for human consumption from a chicken back piece (2), the food product comprising at least one scapula bone (3, 4) of the chicken, the method comprising the steps: inserting a knife (6) in the length direction adjacent to the backbone (5) on its first side and subsequently on its second side in the width direction (W) of the backbone (5) and cutting the meat in the first and second width direction (W) under the first and second scapula bone (3, 4); inserting the knife (6) in the width direction (W) above the backbone (5) and subsequently cutting in the length direction (L) between the backbone (5) and the scapula bones (3, 4) so that the food product (8) comprising both scapula bones (3, 4) is removed from the backbone (5).

The invention relates to a method for obtaining a food product for human consumption from a chicken back piece, the food product comprising at least one scapula bone of the chicken.

The object of the present invention is to provide a method for obtaining a food product for human consumption from a chicken back piece, more preferably the food product is a delicacy, which, as far as known, has not been previously marketed as such. In the following, the product according to the invention will (also) be referred to under the name “chicken butterfly” and “chicken cutlet”.

The product “chicken butterfly” is anatomically a product that is not yet available on the market. This is because the product has not yet been discovered and produced. Up till now, a method for obtaining a chicken butterfly containing both scapula bones is not available. The chicken butterfly is not available in a supermarket or at the butcher, nor is this piece of chicken marketed or mentioned/cited on the internet when searching for the anatomy of the chicken. The inventor has serendipitously discovered and created this piece of chicken from a back piece of the chicken, which usually is sold as scrap meat. After further research of the inventor, a new manual method for cutting and filleting this piece of chicken was developed using special cutting techniques, whereby the product, the chicken butterfly, is separated from the back piece.

The term back piece refers to a piece of the chicken comprising portions of the back of the chicken. After removing the main edible parts from the chicken carcass like the breast, wings and legs, the back piece and other scrap meat parts remain behind. Anatomically the back piece comprises portions of:
the chicken's front back;
the top of the chicken's ribcage;
the front neck;
the upper spine or backbone;
both scapula bones.

The term chicken butterfly refers to a meat cut obtained from the back piece, wherein the backbone has been removed, but still includes both scapula bones.

The chicken butterfly is a unique piece, which anatomically contains different portions of meat of different pieces of the chicken, thereby preserving the taste and flavours of the different parts of the chicken. To obtain this product a new cutting technique has been developed, leaving both scapula bones in the filleted piece of chicken meat, making the chicken butterfly readily available to the consumer.

(The chicken butterfly product is not a chicken butterfly without the two scapula bones).

In U.S. Pat. No. 6,280,311 a method is disclosed of cutting and boning a whole turkey carcass to create a meat cut including a scapula bone with meat attached to the scapula bone. In a first step cross-shaped incisions are made in the back of the turkey, thereby separating the left and right scapula bone; in a second step a turkey rib cut is obtained by grabbing the rear corner flap with one hand and with the other hand cutting the left rib scapula part with a knife from the backbone of the turkey carcass; in a third step the right rib scapula part is cut from the backbone.

This method has the disadvantage that the two scapula bones must be separated first in order to be able to form the corner flaps on the back of the turkey to be able to grab and pull up and out by hand the scapula bone with attached meat. Furthermore, this known method can only by applied to a whole carcass and is not suitable for small parts of a chicken, such as the back piece. A chicken carcass is processed differently due to its smaller size and large global consumption. At the abattoir high speed automated processes are used to divide the chicken into food products like drumsticks, chicken wings et cetera. After or during processing the chicken, the carcass is divided into several parts among which the back piece containing the scapula bones and a portion of the backbone. Commonly, this back piece is sold as scrap meat e.g., for preparing chicken soup.

Object of the present invention is therefore to provide a method for cutting the scrap back piece of a chicken and to provide a chicken cut comprising both scapula bones, which chicken cut can be marketed as a food product as a ‘chicken butterfly’; a further object of the invention is to provide a method for cutting the ‘chicken butterfly’ and to provide a ‘chicken cutlet’ comprising one scapula bone.

These objects are achieved by the method according to the invention whereby in a first step a knife is inserted in the length direction adjacent to the backbone on its first side in the width direction of the backbone and subsequently cutting the meat in the first width direction under the first scapula bone;
in a second step the knife is inserted in the length direction adjacent to the backbone at its second side in the width direction of the backbone and subsequently cutting the meat in the second width direction under the second scapula bone;
in a third step the knife is inserted in the width direction above the backbone and subsequently the meat is cut in the length direction between the backbone and the scapula bones so that the food product comprising both scapula bones is removed from the backbone.

By firstly inserting the knife parallel to the backbone into the meat of the back piece, the portion of the back piece containing the scapula bone is separated by an incision from the portion of the back piece containing the backbone. Then, the chicken butterfly food product containing both scapula bones can easily be separated from the back piece by means of an incision in the length direction.

Preferably, the back piece comprises at least one portion from:
the chicken's front back;
the top of the chicken's ribcage;
the front neck;
the upper spine or backbone.

When different parts of the chicken are included in the product, the tastes and flavours are combined, providing a more complex and improved tasting food product.

Preferably, the method further comprising the step: cutting the food product with the two scapula bones in the length direction with the knife and providing two food products, each comprising one of the scapula bones of a chicken.

More preferably, the method further comprising the step: partially removing the meat from the scapula bone so that a food product is obtained having a scapula bone which partially protrudes outside the food product. This product is called a chicken cutlet, because it resembles the cutlet of red meat. Advantageously, the bare bone part can be used as a handle to pick up and eat the chicken cutlet food product. Furthermore, the chicken cutlet has an aesthetically pleasing appearance and can be eaten as finger food.

In the chicken butterfly both scapula bones remain on either side of the food product; as it were in the meat portion. In the chicken cutlet food product only one scapula bone is present, the scapula bone partially protruding out from the food product.

Both mentioned products according to the invention are hitherto not available anywhere else. Using special techniques with special tools makes it possible to make this unique piece of chicken butterfly & chicken cutlet available to the consumer. This is done with special tools and a special filleting technique. Producing the food product according to the invention may be performed by hand or by means of a (dedicated) machine.

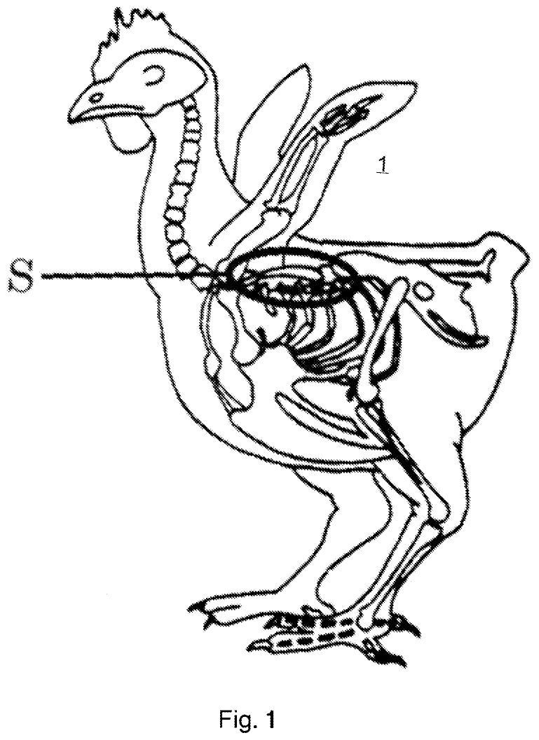

FIG. 1 schematically shows the anatomy of a chicken with an indication of an area S of the location of the back piece comprising both scapula bones;

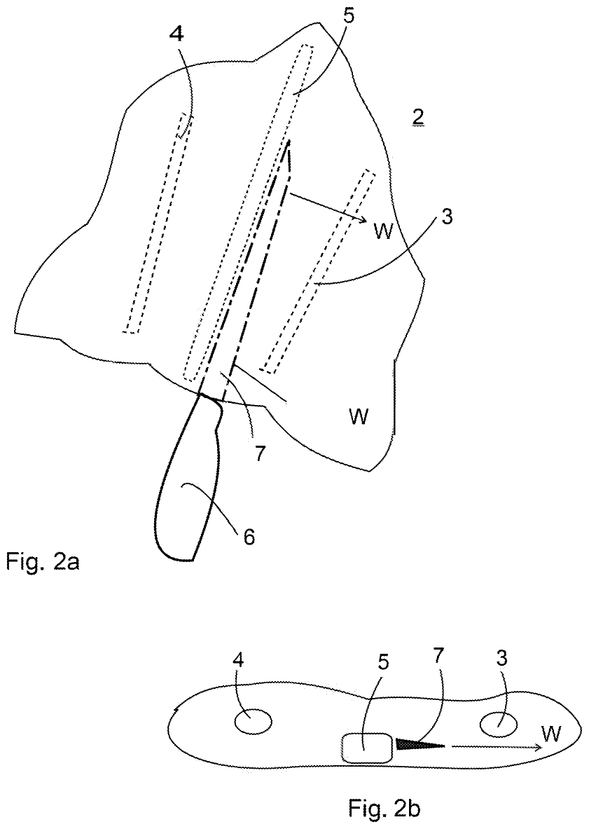

FIG. 2a in top view and FIG. 2b in cross-sectional view of FIG. 2a show the first step of the method according to the invention;

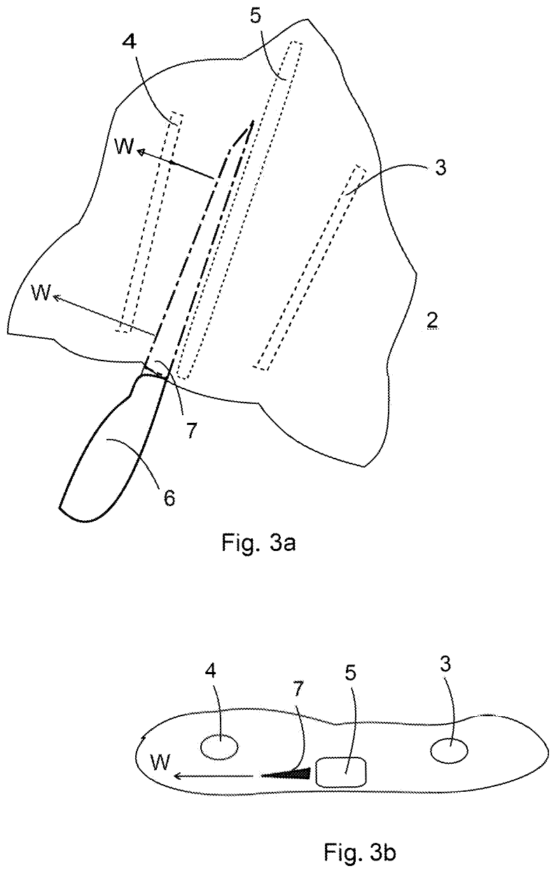

FIG. 3a in top view and FIG. 3b in cross-sectional of FIG. 3a show the second step of the method according to the invention;

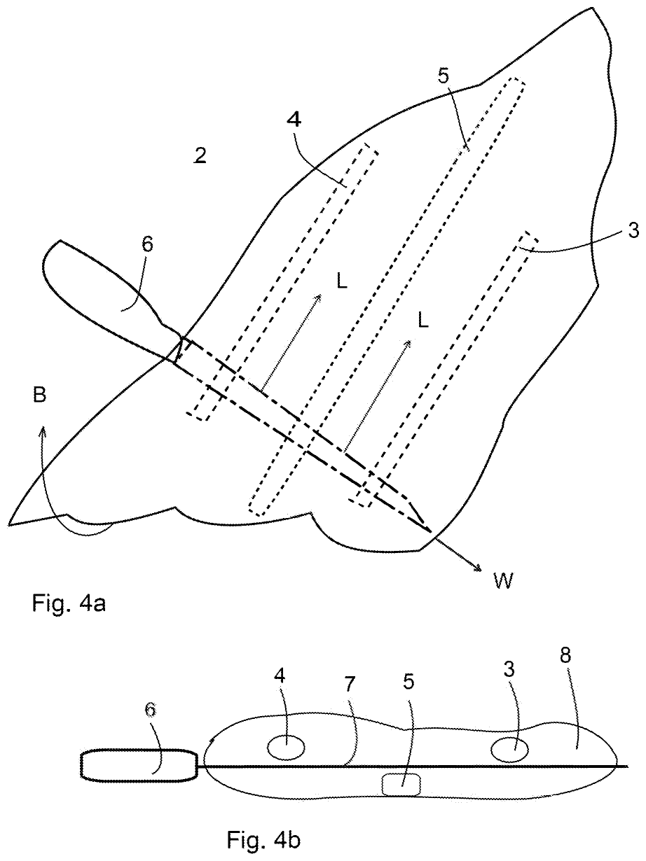

FIG. 4a in top view and FIG. 4b in in cross-sectional view show the third step of the method according to the invention;

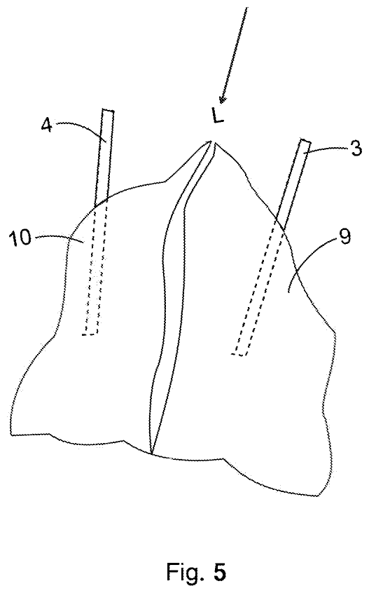

FIG. 5 shows in top view a pair of chicken cutlets, each with a scapula bone.

FIG. 1 shows a chicken 1 with its carcass. The area indicated with S is the area where the back piece is obtained.

FIG. 2a shows in top view the top side of the back piece 2 of the chicken originating from the area S in FIG. 1. In the back piece 2 a first (or right) scapula bone 3 is shown and a second (or left) scapula bone 4. Furthermore, a part of the backbone 5 of the chicken is included in the back piece 2. The back piece 2 essentially consists of meat and the aforementioned bones. In the first step of the method according to the invention a knife 6 is inserted into the back piece 2 parallel and adjacent to the backbone, the blade 7 of the knife is located near the first (right-hand) side of the backbone 5. The blade 7 of the knife 6 is easily inserted, because during insertion the blade 7 is guided to some extent by the backbone 5. Subsequently, the knife 6 and the blade 7 cut the meat on the first (right) part of the back piece 2 in the width direction (arrow) W of the back piece 2. In FIG. 2b in cross-sectional view of FIG. 2a is clearly shown, that the blade 7 is positioned adjacent to the backbone 5 and cuts the meat of the back piece 2 in the width direction (arrow) W under the first (right) scapula bone 3.

FIG. 3a shows in top view that in the second step according to the invention the knife 6 is inserted into the back piece 2 parallel and adjacent to the left-hand side of the backbone, the blade 7 of the knife is located near the backbone 5. The blade 7 of the knife 6 is easily inserted here too, because the blade 7 is also guided by the left side of the backbone 5. Subsequently, the blade 7 of the knife 6 cuts the meat on the second (left) part of the back piece 2 in the width direction (arrow) W of the back piece 2. In FIG. 3b in cross-sectional view of FIG. 3a is shown, that the blade 7 is positioned on the second (left) side adjacent to the backbone 5 and cuts the meat of the back piece 2 in the width direction (arrow) W under the second (left) scapula bone 4.

FIG. 4a shows in top view that in the third step according to the invention the knife 6 is inserted into the back piece 2 transverse to the backbone 5 in the width direction W, the blade 7 of the knife 6 is located near the top of the backbone 5. Now, the blade 7 of the knife 6 cuts the meat on top of the backbone 5 in the length direction L so that the backbone 5 is separated from the upper parts (chicken butterfly) of the back piece 2. Removal of the chicken butterfly is essentially illustrated by arrow B. In FIG. 4b in cross-sectional view of FIG. 4a is shown, that the blade 7 of the knife 6 is positioned between the backbone 5 and both scapula bones 3, 4. The blade 7 is easily inserted into the back piece 2, because on the first (right-hand) side of the back piece the incision made in the first step is available for guiding the blade 7 and on the second (left hand) side of the back piece the incision made in the second step is available for guiding the blade 7.

The chicken butterfly food product 8 is substantially the upper part of the back piece 2 including both scapula bones 3, 4, as can be seen from FIG. 4b.

The chicken butterfly food product 8 may be divided into two, essentially equal parts, by cutting the chicken butterfly from top to bottom or vice versa in the length direction L. Referring to FIG. 5, two food products 9, 10 are obtained, each comprising one of both scapula bones 3, 4 of the chicken butterfly. In the alternative embodiment shown, parts of the meat around the scapula bones 3, 4 are removed, so that a pair of food products 9, 10 is obtained having a portion of (bare, exposed) scapula bone 3, 4 partially protruding out of the food product. These food products 9, 10 having one (partially bare) scapula bone is also called a chicken cutlet.

1. Method for obtaining a food product for human consumption from a chicken back piece, the food product comprising at least one scapula bone of the chicken, the method comprising the steps:
inserting a knife in the length direction adjacent to the backbone (5) on its first side in the width direction of the backbone and subsequently cutting the meat in the first width direction under the first scapula bone;
inserting the knife in the length direction adjacent to the backbone at its second side in the width direction of the backbone and subsequently cutting the meat in the second width direction under the second scapula bone;
inserting the knife in the width direction above the backbone and subsequently cutting in the length direction between the backbone and the scapula bones so that the food product comprising both scapula bones is removed from the backbone.

2. Method for obtaining a food product for human consumption from a chicken back piece according to claim 1, wherein the back piece comprises at least one portion from:
the chicken's front back;
the top of the chicken's ribcage;
the front neck;
the upper spine or backbone.

3. Method for obtaining a food product for human consumption from a chicken back piece, according to claim 1, the method further comprising the step:
cutting the food product comprising both scapula bones in the length direction with the knife and providing two food products, each comprising one of the scapula bones of a chicken.

4. Method for obtaining a food product for human consumption from a chicken back piece, according to claim 3, the method further comprising the step:
partially removing the meat from the scapula bone so that a food product is obtained having a scapula bone which partially protrudes outside the food product.

5. Food product obtained from a back piece of a chicken with the method according to claim 1, the food product comprising at least one scapula bone from the chicken.
